(19) United States
(12) Patent Application Publication
(10) Pub. No.: US 2009/0194654 A1
(43) Pub. Date: Aug. 6, 2009

(54) SLIMSTYLE PANEL FOR WALL SWITCH/RECEPTACLE

(75) Inventor: Paul Lin, Strathfield (AU)

Correspondence Address: SCHMEISER, OLSEN & WATTS, 22 CENTURY HILL DRIVE, SUITE 302, LATHAM, NY, 12110, US

(73) Assignee: KOLEX PTY LTD AS TRUSTEE FOR THE KOLEX DISCRETIONARY TRUST, Strathfield (AU)

(21) Appl. No.: 12/366,694

(22) Filed: Feb. 6, 2009

(30) Foreign Application Priority Data
Feb. 6, 2008 (AU) 2008900541
May 30, 2008 (AU) 20080202392

(51) Int. Cl. A47G 29/00; H02B 1/40

(52) U.S. Cl. 248/231.91; 174/503

(57) ABSTRACT

A slimstyle mounting panel (20) for electric switching gear (10) adapted to be mounted on a standard size mounting block (50) or bracket (60), said panel (20) comprising a non-metallic moulded planar plate portion (46) having (a) on a rearward surface (44), means (24) devised for securing switching gear onto the plate (46); (b) an opening extending from the rearward surface (44) to the front surface (42) of the plate (46), devised for locating an operating element of the switching gear (10); and (c) at least two through holes (38,40) extending through the plate (46) and arranged for receiving screws or other fixing elements by way of which the panel (20) may be secured to a mounting block (50) or bracket (60) disposed at a wall; wherein the axial length of the through holes is one to three times the thickness of the plate portion (46).

### FIELD OF THE INVENTION

The invention relates generally to the field of electric switches and power sockets as used in houses, factories etc for switching on/off a light or providing power to electric devices, and more particularly to slimstyle electric switch and/or power socket assemblies.

### BACKGROUND TO THE INVENTION

An electric switch, usually located in a wall, is typically connected to and used to switch electric power to a light, power socket, or some other electric device. These switches are generally mounted into a rectangular mounting panel which itself is secured to cover and/or enter into a mounting hole of a wall. Usually, such panels also include one or more power sockets which the switch is used to control.

In order to locate and secure these panels at the wall, they are typically fixed to a mounting block or bracket positioned in a hollow space within the wall. Standard mounting panels, however, are bulky and protrude to a substantial degree from the surface of the wall on which they are located.

Recently, slimstyle mounting panels have become available, wherein the thickness of the panel assembly mounted to the surface of the wall is minimized resulting in a more attractive slimstyle appearance. Typically, the thickness of a slimstyle or slim-style panel is recognized as being less than about 4.50 mm. However, these slimstyle panels are only able to be mounted on mounting blocks or brackets specifically configured for the slimstyle panels, i.e., non-standard mounting blocks or brackets. Accordingly, since these slimstyle panels are not able to be mounted on standard mounting blocks or brackets, retro fitting such plates in an existing building is not only expensive, but involves a time consuming process of replacing the mounting blocks or brackets within the wall cavities, as well as the mounting panels themselves.

Where the slimstyle panels are to be utilized in a new building, the installer's choices of mounting blocks or brackets are limited to those mounting blocks or brackets specifically designed to accommodate the slimstyle panels.

One object of the invention is to provide a slimstyle mounting panel for electric switching gear, which is adapted to be mounted to an existing standard sized mounting block or bracket.

### SUMMARY OF THE INVENTION

Accordingly, in one aspect, the invention provides a slimstyle mounting panel for electric switching gear adapted to be mounted on a standard size mounting block or bracket, said panel comprising:

a non-metallic moulded planar plate portion having
(a) on a rearward surface, means devised for securing switching gear onto the plate;
(b) an opening extending from the rearward surface to the front surface of the plate, devised for locating an operating element of the switching gear; and
(c) at least two through holes extending through the plate and arranged for receiving screws or other fixing elements by way of which the panel may be secured to a mounting block or bracket disposed at a wall;
wherein the axial length of the through holes is one to three times the thickness of the plate portion.

In another aspect, the invention provides a slimstyle mounting panel for electric switching gear adapted to be mounted on a standard size mounting block

or bracket, said panel comprising:
a non-metallic moulded planar plate portion having
(a) on a rearward surface, means devised for securing switching gear onto the plate;
(b) an opening extending from the rearward surface to the front surface of the plate, devised for locating an operating element of the switching gear; and
wherein said panel is integrally formed with at least two plate-like mounting portions, each said mounting portion fitted with a metallic insert for providing rigidity and a through hole adapted to receive a screw or similar fixing element for securing the panel to a mounting block or bracket disposed at a wall.

The invention advantageously provides a slimstyle mounting panel with means to allow the panel be secured to, and sit flush against, the surface of a standard sized mounting block or bracket. It will be appreciated that the area at the rearward surface of the planar plate portion surrounding the through holes is relatively flat. This is in contrast to prior art slimstyle mounting panels, which, in order to impart rigidity, typically provide a raised boss structure on the rearward surface of the planar plate portion surrounding the through holes, preventing use of the panel with standard sized mounting blocks or brackets.

The term mounting block or bracket is intended to be interpreted broadly to include supporting structures which are adapted to secure mounting panels at a wall. Typically, such supporting structures will be formed of plastic or metal, and at least a part of the supporting structure will extend into a wall cavity and be secured to framework within the wall or the wall itself. It is commonplace for the mounting block or bracket to have threaded mounting holes located to axially align with those of the mounting panel when this is in place.

The term electric switching gear is intended to be interpreted broadly to include any suitable configuration of electric mechanisms and toggles for switches, power sockets and/or similar connections. This may include arrangements which are made up entirely of one or switches, or one or more power sockets. Such gear is typically a moulded arrangement which is able to be fitted to a mounting panel after the mounting panel has been moulded.

Preferably, the through holes terminate substantially flush within the plate portion such as to not extend substantially beyond the rearward surface of the plate portion.

The panel may further comprise reinforcing members disposed around the through holes whose thickness is about the same or less than the axial length of the through holes.

Advantageously, the reinforcing members can be metallic plates received either in a receptacle cavity within the plate portion, or on the front or rearward surface. Such plates provide reinforcement to the through holes, allowing them to withstand forces applied to the plate when, for example, plugs are removed from power sockets, without the need for bulky bosses as provided in the prior art, as discussed above.

In one form, the metallic plates are moulded in the plate portion.

In another form, the metallic plates are secured in position using glue or similar fixing means.

Advantageously, the through holes comprise a counter sunk zone opening towards the front surface. The metallic insert could also or alternatively be at least partly U-shaped.

These features advantageously allow counter-sinking of a screw so that the head of the screw does not extend beyond the front surface of the plate.

The panel may further comprise a plurality of reinforcing ridges, webs, flanges or similar rigidity enhancing elements on the rearward surface of the plate portion.

The panel could also further comprise a plurality of notches for removably retaining a face plate adapted to be positioned over the front surface of the plate portion so as to hide the screws or other fixing elements from view when the panel is secured to the mounting block or bracket.

Embodiments of the present invention will now be described with reference to the accompanying drawings.

### BRIEF DESCRIPTION OF THE DRAWINGS

FIG. 1 is an perspective view of a prior art slimstyle mounting panel;

FIG. 2 is a top view of the front of a mounting panel in accordance with one embodiment of the present invention;

FIG. 3 is a top view of the back of the mounting panel illustrated in FIG. 2;

FIG. 4 is side perspective view of the mounting panel illustrated in FIG. 2 positioned in relation to a mounting block and bracket;

FIG. 5 is a perspective view of the front of the mounting panel illustrated in FIG. 2;

FIG. 6 is a perspective view of the back of the mounting panel illustrated in FIG. 2;

FIG. 7 is a perspective view of the mounting panel illustrated in FIG. 2 with one end cut away to show a metallic reinforcing member; and

FIG. 8 is a cross-sectional side view of the mounting panel illustrated in FIG. 2 showing a metallic reinforcing member.

### DESCRIPTION OF PREFERRED EMBODIMENTS

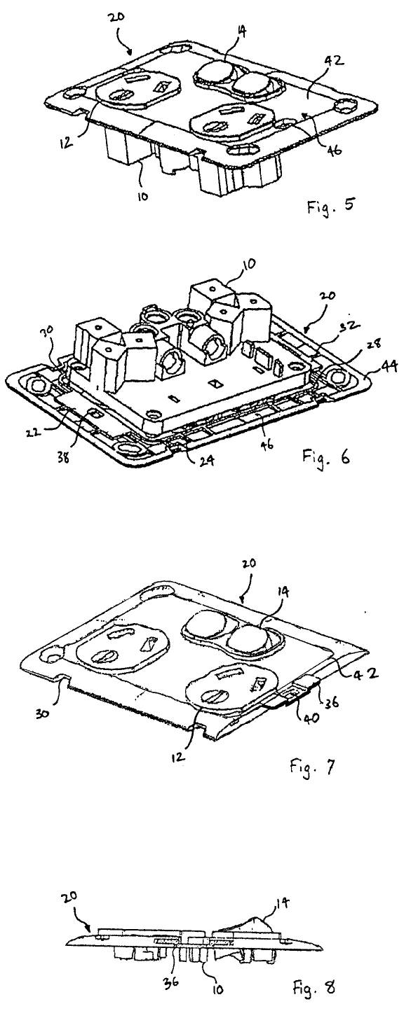

Referring first to FIGS. 3 and 6, a non-metallic moulded slimstyle mounting panel 20 consistent with an embodiment of the present invention is shown and described. In this embodiment, the mounting panel 20 includes a planar plate portion 46 provided with a first integrally formed and plate-like mounting portion 22, an electric switching gear receiving section 24, a second integrally formed and plate-like mounting portion 26, a skirt 28 interposed between the switching gear receiving section 24 and each of the mounting plates 22 and 26, face plate receiving notches 30, and reinforcing skirts 32.

The mounting panel 20 may be composed of injection moulded plastic, or some other desired non-metallic rigid material, so as to retain a electric switching gear 10. including the sockets 12 and toggle switches 14 (as best seen in FIG. 5) firmly in position. The electric switching gear 10 is a typical moulded arrangement including the necessary electric mechanisms for operating the switches and/or sockets provided on the mounting panel 20. It will be appreciated that the electric switching gear 10 does not form part of the invention and can vary in relation to the switches and/or sockets provided.

The mounting panel 20 is provided with at least one opening extending from the rear web 44 to the front web 42 of the plate through which a toggle switch 14 can project for use by a user. The mounting panel 20 may also be moulded with one or more sockets 12 on the front web 42 of the panel 20 and is of a size suitable for a standard mounting block 50 or bracket 60 located within a hollow in a wall.

As illustrated in FIGS. 2, 7 and 8, each of the mounting plates 22 and 26 are fitted with U-shaped metallic inserts 34 and 36 and provided with counter sunk through holes 38 and 40, through which screws or other similar fixing elements may be inserted. In an alternative embodiment, the metallic inserts may be formed from some other suitable material and/or may take another form such as a flat plate which is positioned in a suitable position between front web 42 and the back web 44 of the mounting panel 20, so as to reinforce the counter sunk through holes 38 and 40.

The through holes 38, 40 are spaced so as to align with the respective receiving holes on the mounting block 50 or bracket 60.

The metallic inserts 34, 36 may be positioned in a receptacle cavity between the front web 42 and the back web 44 of the mounting panel 20 and fixed in place during the moulding process. Alternatively, the metallic inserts 34, 36 may simply be positioned within the planar plate portion 46, or on the front web 42 and the back web 44 of the mounting panel 20 and preferably, fixed in place using a suitable glue or like fixing means.

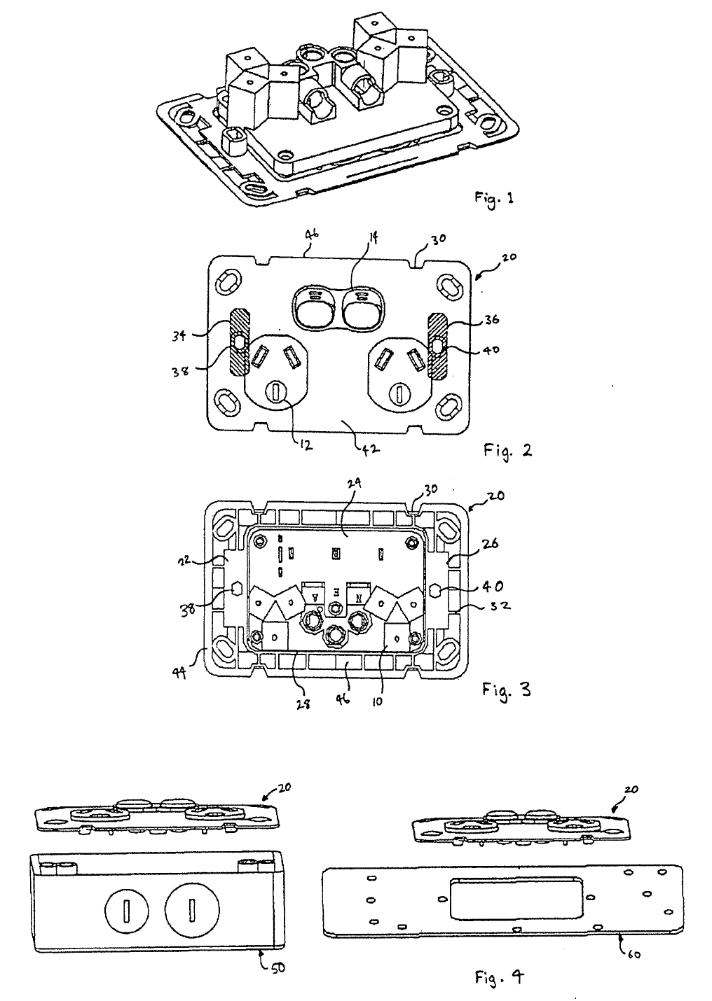

The metallic inserts 34, 36 provide reinforcement to the through holes 38, 40 allowing them to withstand forces applied to the plate when, for example, plugs are removed from sockets, without the bulky bosses provided in the prior art, as illustrated in FIG. 1. It will be appreciated that the axial length of the through holes 38,40 is one to three times the thickness of the plate portion 46. The prior art slimstyle mounting plates, on the other hand, typically provide a raised boss structure on the rearward surface of the planar plate portion surrounding the through holes, preventing the panel from being secured to and/or sit flush against a standard sized mounting block 50 or bracket 60.

Each of the metallic inserts 34, 36 retain, for example, the head of a screw within the counter sunk through holes 38, 40, allowing the panel 20 to be fastened to a mounting block 50 or bracket 60 (as illustrated in FIG. 4).

The centering ridge portion 28 of the mounting panel 20 may be used to center and retain the switching gear 10 within the mounting block 50 or bracket 60, so that the mounting panel 20 is able to be secured to, and sit flush against, the mounting block 50 or bracket 60.

The mounting panel 20 may also be provided with cover-panel receiving notches 30 consisting of, in one form, four notches adapted to removably retain a cover plate (not shown) over the front web 42 of the panel 20 so as to hide the mounting plates 22, 26, including through holes 38, 40 and the relevant fixing elements. from view when the mounting panel 20 is fixed to the mounting block 50 or bracket 60.

While the invention has been particularly shown and described with reference to the preferred embodiments thereof, it will be understood by those skilled in the art that the foregoing and other changes in form and details may be made therein without departing from the spirit and scope of the invention.

1-19. (canceled)

20. A slimstyle mounting panel for electric switching gear adapted to be mounted on a standard size mounting block or bracket, said panel comprising:
a non-metallic moulded planar plate portion having
(a) on a rearward surface, means devised for securing switching gear onto the plate;
(b) an opening extending from the rearward surface to the front surface of the plate, devised for locating an operating element of the switching gear; and
(c) at least two through holes extending through the plate and arranged for receiving screws or other fixing elements by way of which the panel may be secured to a mounting block or bracket disposed at a wall;
wherein the axial length of the through holes is one to three times the thickness of the plate portion.

21. A slimstyle mounting panel according to claim 20, wherein said through holes terminate substantially flush within said plate portion such as to not extend substantially beyond said rearward surface of the plate portion.

22. A slimstyle mounting panel according to claim 20, the panel further comprising reinforcing members disposed around the through holes, the thickness of the reinforcing members being about the same or less than the thickness of the plate portion.

23. A slimstyle mounting panel according to claim 22, wherein the reinforcing members include metallic plates received either in a receptacle cavity within the plate portion, or on the front or rearward surface.

24. A slimstyle mounting panel according to claim 23, wherein the metallic plates are at least partly U-shaped.

25. A slimstyle mounting panel according to claim 24, wherein the metallic plates are moulded in the plate portion.

26. A slimstyle mounting panel according to claim 23, wherein the metallic plates are secured in position using glue or similar fixing means.

27. A slimstyle mounting panel according to claim 20, wherein the through holes comprise a counter sunk zone opening towards the front surface.

28. A slimstyle mounting panel according to claim 20, wherein the panel further comprises a plurality of reinforcing ridges, webs, flanges or similar rigidity enhancing elements on the rearward surface of the plate.

29. A slimstyle mounting panel according to claim 20, wherein the panel further comprises a plurality of notches for removably retaining a face plate adapted to be positioned over the front surface of the panel so as to hide the screws or other fixing elements from view when the panel is secured to the mounting block or bracket.

30. A slimstyle mounting panel for electric switching gear adapted to be mounted on a standard size mounting block or bracket, said panel comprising:
a non-metallic moulded planar plate portion having
(a) on a rearward surface, means devised for securing SWitching gear onto the plate;
(b) an opening extending from the rearward surface to the front surface of the plate, devised for locating an operating element of the switching gear; and
wherein said panel is integrally formed with at least two plate-like mounting portions, each said mounting portions fitted with a metallic insert for providing rigidity and a through hole adapted to receive screws or similar fixing elements for securing the panel to a mounting block or bracket disposed at a wall.

31. A slimstyle mounting panel as per claim 30, wherein thickness of the platelike mounting portions is about the same or less than the thickness of the plate portion.

32. A slimstyle mounting panel according to claim 30, wherein metallic inserts are fitted either in a receptacle cavity within the plate portion, or on the front or rearward surface.

33. A slimstyle mounting panel according to claim 30, wherein the metallic inserts are at least partly U-shaped.

34. A slimstyle mounting panel according to claim 30, wherein the metallic inserts are moulded in the plate portion.

35. A slimstyle mounting panel according to claim 30, wherein the metallic inserts are secured in position using glue or similar fixing means.

36. A slimstyle mounting panel according to claim 30, wherein the through holes comprise a counter sunk zone opening towards the front surface.

37. A slimstyle mounting panel according to claim 30, wherein the panel further comprises a plurality of reinforcing ridges, webs, flanges or similar rigidity enhancing elements on the rearward surface of the plate portion.

38. A slimstyle mounting panel according to claim 30, wherein the panel further comprises a plurality of notches for removably retaining a face plate adapted to be positioned over the front surface of the panel so as to hide the screws or other fixing elements from view when the panel is secured to the mounting block or bracket.
